(19) United States
(12) Patent Application Publication
(10) Pub. No.: US 2020/0332839 A1
(43) Pub. Date: Oct. 22, 2020

(54) DAMPING ARRANGEMENT FOR DAMPENING ROTATIONAL IRREGULARITIES IN A DRIVE TRAIN OF A MOTOR VEHICLE

(71) Applicant: ZF FRIEDRICHSHAFEN AG, Friedrichshafen (DE)

(72) Inventors: Tobias DIECKHOFF, Würzburg (DE); Mathias KOPP, Bamberg (DE); Alfred TAREILUS, Schweinfurt (DE); Christofer EBERT, Hafenlohr (DE)

(21) Appl. No.: 16/757,028

(22) PCT Filed: Sep. 19, 2018
(86) PCT No.: PCT/EP2018/075261

§ 371 Date: Apr. 17, 2020

(30) Foreign Application Priority Data
Oct. 19, 2017 (DE) 10 2017 218 686.0

(51) Int. Cl. F16D 7/00; F16F 15/00; F16D 48/06; F16F 15/10

(52) U.S. Cl. CPC F16D 7/00; F16F 15/002; F16D 48/06; F16F 15/10; F16F 2230/08; F16D 2500/308; F16F 2230/18; F16F 2232/02; F16D 2300/18; F16D 2300/22; F16F 2230/0047

(57) ABSTRACT

A damping arrangement for dampening rotational irregularities in a drive train of a motor vehicle, having a slip arrangement providing slip between an input and output region of a torque-transmitting arrangement. The slip arrangement has a closed-loop control device that performs closed-loop control of the slip dependent on a measured signal for a rotational irregularity. The closed-loop control device performs closed-loop control of the slip dependent on at least one characteristic variable of a periodic oscillation component of an alternating component of a rotational speed proceeding from an average rotational speed. A sensor device is connected to the closed-loop control device and is designed to ascertain the average rotational speed in the torque-transmitting path downstream of the slip arrangement and to ascertain a frequency of the alternating component in the torque-transmitting path upstream of the slip arrangement.

### CROSS REFERENCE TO RELATED APPLICATIONS

This is a U.S. national stage of Application No. PCT/EP2018/075261 filed Sep. 19, 2018. Priority is claimed on German Application No. DE 10 2017 218 686.0 filed Oct. 19, 2017 the content of which is incorporated herein by reference.

### BACKGROUND OF THE INVENTION

### 1. Field of the Invention

The invention relates to a damping arrangement for dampening rotational irregularities in a drive train of a motor vehicle, comprising a slip arrangement that provides slip between an input region and output region of a torque-transmitting arrangement, wherein the slip arrangement comprises a closed-loop control device designed to perform closed-loop control of the slip in a manner dependent on a measured signal for a rotational irregularity.

The invention furthermore relates to a method for dampening rotational irregularities in a drive train of a motor vehicle, wherein, a slip arrangement provides slip between an input region and an output region of a torque-transmitting arrangement, and wherein, by a closed-loop control device performs closed-loop control of the slip in a manner dependent on a measured signal for a rotational irregularity.

Although applicable to any motor vehicles, the present invention will be discussed with regard to motor vehicles in the form of passenger motor vehicles with an internal combustion engine.

### 2. Description of Related Art

To increase efficiency and fuel savings in passenger motor vehicles with internal combustion engines, a wide variety of solutions have become known, for example engines with cylinder deactivation, start-stop systems, and/or various stages of hybridization. This however leads, in passenger motor vehicle drive trains, to increased rotational irregularity or increasing excitations, in particular in the low rotational speed range, for example from the idle rotational speed up to approximately 1400 rpm.

To dampen such rotational irregularities, not only spring-mass arrangements, for example dual-mass flywheels, but also rotational-speed-adaptive absorbers are known. Furthermore, in drive trains with a wet-running launch element, it has also become known to realize a reduction in the torque fluctuations of the internal combustion engine by a slip in the launch element. Here, a predefined average slip rotational speed is set. Furthermore, it has become known from DE 10 2008 009 135 A1 to reduce a rotational speed difference, prevailing at a friction clutch, of a resonance rotational speed range upon launching through corresponding actuation of the friction clutch.

A method for determining slip of a clutch has become known from WO 99/23392 A1.

Furthermore, from US 2004/0260444 A1, a damping arrangement is known that comprises a clutch and a sensor arrangement, wherein the clutch is actuated based on signals of the sensor arrangement to prevent oscillations in the drive train. Here, the rotational speed of an input shaft and the speed of a wheel of the motor vehicle are used as parameters for the closed-loop control of the clutch for the purposes of dampening oscillations.

A method for isolating rotational oscillations is known from WO 2004/018890 A2. Here, closed-loop control of the slip between a drive input element and a drive output element of a clutch is performed in a manner dependent on oscillation signals which are transmitted by an oscillation sensor to a corresponding closed-loop control device.

### SUMMARY OF THE INVENTION

A disadvantage of the methods that are already known is that they are inflexible and therefore provide unsatisfactory decoupling or dampening of rotational irregularities. Furthermore, they require heavy and therefore expensive components for pre-decoupling that is to be performed for rotational irregularities.

An object of one aspect of the present invention is a damping arrangement and a method for dampening rotational irregularities that, in particular with unchanged friction losses, achieve improved decoupling.

It is a further object of one aspect of the present invention to specify a damping arrangement and a method for dampening rotational irregularities that provide a level of decoupling substantially equal to that of known methods and systems, wherein more lightweight and less expensive components can be used for the pre-decoupling.

One aspect of the present invention is a damping arrangement for dampening rotational irregularities in a drive train of a motor vehicle, comprising a slip arrangement for providing slip between an input region and output region of a torque-transmitting arrangement, wherein the slip arrangement comprises a closed-loop control device designed to perform closed-loop control of the slip in a manner dependent on a measured signal for a rotational irregularity, in that the closed-loop control device is designed to perform closed-loop control of the slip in a manner dependent on at least one characteristic variable of a periodic oscillation component of an alternating component of a rotational speed proceeding from an average rotational speed, and in that a sensor device is provided that is connected to the closed-loop control device, wherein the sensor device is designed to ascertain the average rotational speed in the torque-transmitting path downstream of the slip arrangement, and wherein the sensor device is designed to ascertain a frequency of the alternating component in the torque-transmitting path upstream of the slip arrangement.

One aspect of the present invention achieves the objects, in the case of a method for dampening rotational irregularities in a drive train of a motor vehicle, wherein, by a slip arrangement, slip is provided between an input region and an output region of a torque-transmitting arrangement, and wherein, by a closed-loop control device, closed-loop control of the slip is performed in a manner dependent on a measured signal for a rotational irregularity, in that, by the closed-loop control device, closed-loop control of the slip is performed in a manner dependent on at least one characteristic variable of a periodic oscillation component of an alternating component of a rotational speed proceeding from an average rotational speed, and in that, by a sensor device connected to the slip arrangement, the average rotational speed in the torque-transmitting path downstream of the slip arrangement is ascertained, and a frequency of the alternating component in the torque-transmitting path upstream of the slip arrangement is ascertained.

One of the advantages thereby achieved is that, in particular after the launch process, an advantageous reduction of rotational oscillations is effected. A further advantage is that the efficiency is thus increased, because the closed-loop control device actuates the slip arrangement in accordance with the actual decoupling requirement. Furthermore, the flexibility is increased, because this, in a manner dependent on the driving situation, correspondingly performs closed-loop control of the damping in a manner adapted to the rotational irregularities, such that the energy efficiency in the drive train is increased, and at the same time the damping of the rotational irregularities is improved. A further advantage is that, during ongoing operation, closed-loop control of the rotational irregularities is performed without closed-loop control being performed on the basis of stored parameters, characteristic maps or the like.

In other words, characteristic variables or parameters that are functionally relevant for the damping of rotational irregularities are picked off in the advantageous region of the torque-transmitting arrangement, the characteristic variables or parameters then serving as input variables for the closed-loop control of the slip arrangement.

Further features, advantages and further embodiments of the invention are described, or will become evident, below:

In one advantageous refinement, the sensor device is designed to ascertain an amplitude of the rotational irregularities as a characteristic variable in the torque-transmitting path downstream of the slip arrangement. In other words, the remaining rotational irregularities on the secondary side of the slip arrangement is used as a reference variable. An advantage of this is that a particularly reliable ascertainment of the rotational irregularities is made possible in this way.

In one advantageous refinement, the sensor device has a position sensor for a shaft of a drive of the motor vehicle, in particular a crankshaft position sensor. An advantage of this is that the engine rotational speed and/or the ignition frequency of the engine upstream of the slip arrangement can be ascertained particularly accurately.

In a further advantageous refinement, a rotational irregularity pre-decoupling device, in particular comprising at least one rotational-speed-adaptive absorber, is arranged upstream of the slip arrangement, and the sensor device comprises a primary rotational speed sensor arranged in the torque-transmitting path downstream of the rotational irregularity pre-decoupling device and upstream of the slip arrangement. It is then the case that a major part of the rotational irregularities have already been filtered out at this location in the torque-transmitting path by the rotational irregularity pre-decoupling device, such that a more exact detection of the rotational speed directly at the functionally relevant location at the input region of the slip arrangement is possible.

In a further advantageous refinement, the sensor device comprises, for the ascertainment of the amplitude of the rotational irregularities as characteristic variable, a secondary rotational speed sensor and/or a secondary acceleration sensor arranged in the torque-transmitting path downstream of the slip arrangement. An advantage of this is that the remaining rotational irregularity on the secondary side of the slip arrangement can be detected in a simple manner. This can particularly advantageously be detected by a rotational speed sensor provided in any case for ascertaining the slip rotational speed.

In a further advantageous refinement, a transmission is arranged in the torque-transmitting path downstream of the slip arrangement, and the sensor device is designed to ascertain the amplitude of the rotational irregularities in the torque-transmitting path downstream of the transmission. This permits a particularly reliable ascertainment of the amplitude of the rotational irregularities, because it is commonly the case that no oscillation node is situated at the output of the transmission, such that reliable closed-loop control of the slip for the purposes of damping rotational irregularities is made possible.

In a further advantageous refinement, at least one of the sensors, in particular all sensors, are directly connected to the slip arrangement, in particular to the closed-loop control device thereof. This permits particularly fast closed-loop control of the slip by slip arrangement because, in this way, real-time requirements of the signal processing can be allowed for. Delays via a bus system are thus avoided.

In a further advantageous refinement, the closed-loop control device comprises a memory that comprises starting values for the closed-loop control of the slip arrangement. In this way, it is advantageously possible for the response time, for example for detections of the amplitude, to be shortened when the closed-loop control device commences operation, for example upon starting of the motor vehicle.

In a further advantageous refinement, the closed-loop control device comprises a memory that contains one or more values that represent a predefined decoupling quality, and wherein the closed-loop control device is designed to perform closed-loop control of an amplitude of the slip until the predefined decoupling quality is attained. The efficiency is increased in this way, because the closed-loop control device increases the amplitude of the modulation moment of the alternating component only until such time as the desired decoupling quality has been attained.

In a further advantageous refinement, the slip arrangement comprises a clutch for providing an average slip, and the closed-loop control device is designed to provide an average slip in a manner dependent on at least one of the characteristic variables. An advantage of this is that closed-loop slip control by a clutch is made possible in a simple and at the same time reliable manner.

In an advantageous refinement of the method, oscillation nodes of the periodic oscillation component in the torque-transmitting path are ascertained, and characteristic variables are ascertained by the sensor device outside the ascertained oscillation nodes. Particularly reliable and stable closed-loop control is made possible in this way: the arrangement of a sensor in an oscillation node would have the effect that the characteristic variables for the closed-loop control are detected with an excessively small amplitude or even with no amplitude, or it is even possible for the oscillation in the vicinity of an oscillation node to have an opposite phase in relation to the oscillation of the rotational irregularities that is actually to be attenuated. This could for example result in greater amplitudes than necessary being set, and in the closed-loop control of the slip for the purposes of dampening rotational irregularities becoming unstable overall.

In a further advantageous refinement of the method, the average slip is increased by the slip arrangement if a predefined maximum of an amplitude of the alternating component has been reached. In this way, the decoupling can be further improved despite the alternating component of the slip already being operated with the maximum amplitude.

In a further advantageous refinement, a target decoupling quality is predefined for at least two different positions in the torque-transmitting path, and the amplitude of the alternating component is increased only to such an extent that the target decoupling quality is reached, and this is in particular then kept constant. This greatly increases the efficiency, because no closed-loop control of the slip is performed over and above the desired decoupling quality.

Further important features and advantages of the invention will emerge from the subclaims, from the drawings, and from the associated description of the figures on the basis of the drawings.

It is self-evident that the features mentioned above and the features yet to be discussed below may be used not only in the respectively specified combination but also in other combinations or individually without departing from the scope of the present invention.

### BRIEF DESCRIPTION OF THE DRAWINGS

Preferred designs and embodiments of the invention are illustrated in the drawings and will be discussed in more detail in the following description, wherein the same reference designations are used to denote identical or similar or functionally identical components or elements.

FIG. 1 is a damping arrangement; and

FIG. 2 is a method according to the present invention.

### DETAILED DESCRIPTION OF THE PRESENTLY PREFERRED EMBODIMENTS

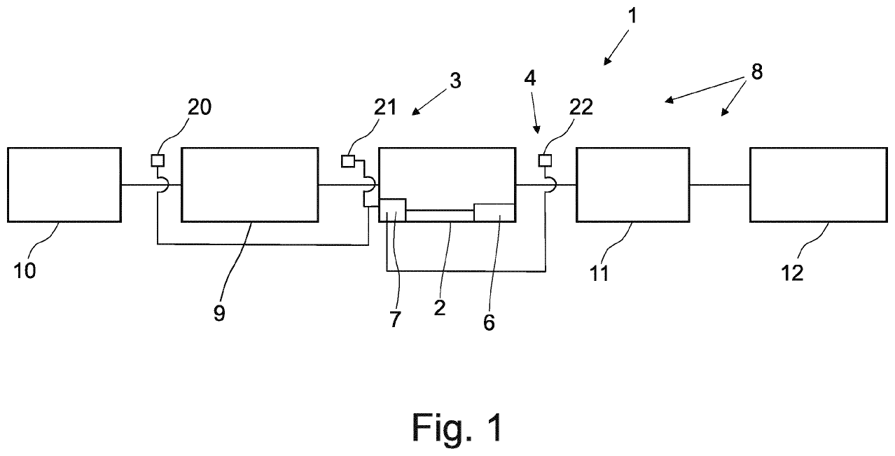

FIG. 1 shows a damping arrangement according to an embodiment of the present invention.

FIG. 1 shows a damping arrangement 1 for a drive train of a motor vehicle. Here, the drive train comprises an engine 10 connected downstream in the torque flow, to a rotational irregularity pre-decoupling element 9. The rotational irregularity pre-decoupling element 9 is connected, further downstream in the torque flow, to a slip arrangement 2, wherein the slip arrangement 2 is connected at an output side to a transmission 11, and the transmission 11 is connected to further transmission elements—denoted in FIG. 1 as the remaining drive train 12. A crankshaft position sensor 20 is arranged between the engine 10 and rotational irregularity pre-decoupling element 9. A rotational speed sensor 21 is arranged between the rotational irregularity pre-decoupling element 9 and the slip arrangement 2, and a further rotational speed sensor 22 is arranged between the slip arrangement 2 and transmission 11. The rotational speed sensor 21 is thus arranged in the input region 3 of the slip arrangement 2, and the rotational speed sensor 22 is arranged in the output region 4 of the slip arrangement 2.

The slip arrangement 2 comprises a closed-loop control device 6 and a sensor device 7. The sensor device 7 is connected to the three sensors 20, 21, and 22 and furthermore directly to the closed-loop control device 6 for the closed-loop control of the slip. This is advantageous owing to the real-time requirement of the signal processing: if the sensors 20, 21, and 22 have a direct data connection to the closed-loop control device 6, the delays that are possible in the case of a transmission via a bus system can be avoided.

The characteristic variables for the closed-loop control of the slip by the slip arrangement will now be described below. Below, these are the frequency, more specifically the modulation frequency, with which the slip is modulated, the average slip rotational speed, the amplitude of the modulation of the slip, and the phase angle thereof.

The modulation frequency, which is to be set by the slip arrangement 2, for the slip is in particular directly proportional to the engine rotational speed. In order to dampen the engine main order which is of particular relevance with regard to comfort, the modulation frequency is adapted exactly to the ignition frequency of the engine 10.

The rotational speed of the engine 10 is preferably ascertained upstream of the slip arrangement 2, because the rotational speed downstream of the slip arrangement 2 has already been reduced by the slip rotational speed. Since the slip rotational speed is variable, it is thus the case downstream of the slip arrangement 2 that there is no longer direct proportionality between the local rotational speed and the ignition frequency. The rotational speed of the engine 10, and/or the ignition frequency thereof, can be ascertained at various positions in the torque-transmitting path 8 upstream of the slip arrangement 2. It may for example be ascertained directly from the engine 10 by a crankshaft position sensor 20. What is particularly advantageous is an arrangement of a rotational speed sensor 21 in the torque-transmitting path 8 downstream of the rotational irregularity pre-decoupling element 9 and upstream of the slip arrangement 2. By the rotational irregularity pre-decoupling element 9, which may for example be composed of an arrangement of springs and rotational-speed-adaptive absorbers, the rotational speed at this location has already had a major part of the rotational irregularities eliminated therefrom. This has the advantages that parts of the rotational speed sensor 21 are subjected to lower mechanical loading, and that a more exact detection of the rotational speed directly at the functionally relevant location at the input region of the slip arrangement 2 is possible.

As a further characteristic variable, the average slip rotational speed is ascertained. For the ascertainment of the slip rotational speed, not only the rotational speed information for the primary side 3 of the slip arrangement 2 but also a rotational speed on the secondary side 4 of the slip arrangement 2 is required. The corresponding rotational speed sensor 22 may, as already stated, be arranged in the torque-transmitting path 8 downstream of the slip arrangement 2. The difference of the two rotational speed signals of the sensors 21 and 22 corresponds to the slip rotational speed, wherein consideration must also be given to the gear-ratio-dependent transmission ratio if the measurement point is not situated between the slip arrangement 2 and the transmission 11.

For the determination of the amplitude for the slip, the remaining rotational irregularity on the secondary side 4 of the slip arrangement 2 is determined as reference variable. This may be detected by an acceleration sensor, but particularly advantageously by the above-described rotational speed sensor 22, which is required in any case for the ascertainment of the slip rotational speed. The closed-loop control device 6 iteratively increases or reduces the amplitude in a manner dependent on the resulting change in the rotational irregularity ascertained by the sensor 22. The sensor 22 may in principle be arranged at any location in the drive train in the torque-transmitting path 8 downstream of the slip arrangement 2. Depending on the drive train, there are however positions at which so-called oscillation nodes occur. At these positions, at certain operating points, only small vibration amplitudes arise, whereas greater amplitudes arise at other positions of the drive train. The arrangement of the sensor 22 at such an oscillation node is unfavorable because, then, the reference variable for the closed-loop control is detected with an excessively small amplitude—or even with no amplitude—or it is even possible for the oscillation in the vicinity of an oscillation node to have an opposite phase in relation to the oscillation that is actually to be attenuated. The closed-loop control device 6 would then set ever greater amplitudes and become unstable.

In the case of a multi-stage automatic transmission for a rear-wheel-drive drive train of a motor vehicle with a rotational irregularity pre-decoupling device 9, comprising a spring accumulator and an oscillation absorber positioned downstream thereof, an oscillation node commonly occurs at the input of the transmission 11 at a particular rotational speed. In this respect, it is advantageous for the rotational speed sensor 22 arranged on the secondary side of the slip arrangement 2 to be arranged at the output of the transmission 11.

The phase angle of the modulation of the slip is preferably controlled in closed-loop fashion together with the amplitude by the closed-loop control device 6. The closed-loop control device 6 thus in particular iteratively adapts not only the amplitude but also the phase angle in accordance with the change in the at least one characteristic variable.

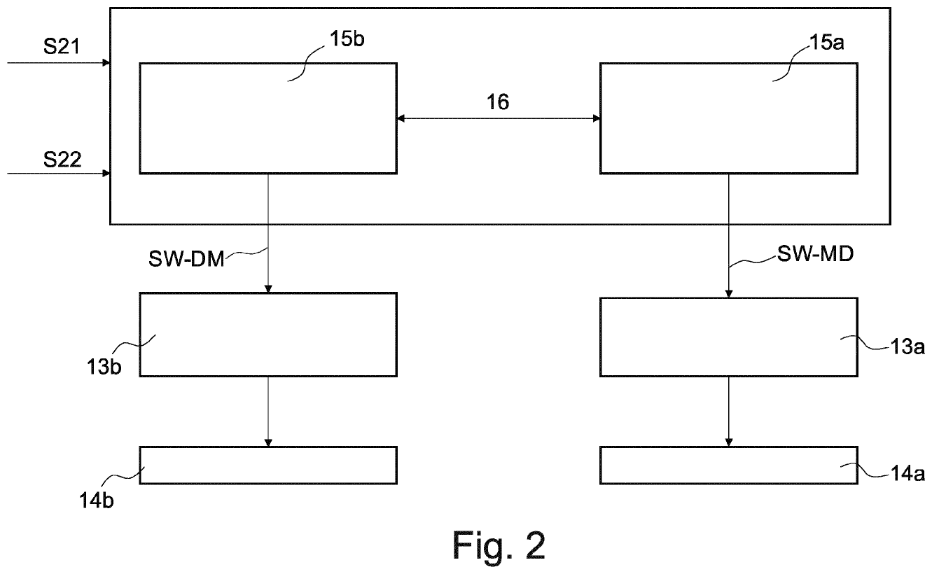

FIG. 2 shows steps of a method according to an embodiment of the present invention.

FIG. 2 schematically shows a slip arrangement 2 with a closed-loop control device 6 and corresponding steps for the closed-loop control of the slip, both of an average rotational speed of the slip and of a slip modulation. As input variables, the primary rotational speed upstream of the slip arrangement 2 is present in the form of a signal S21, and the secondary rotational speed downstream of the slip arrangement 2 is present in the form of the signal S22. The signals S21, S22 are utilized as reference variables both by a closed-loop control algorithm 15b for the Mode 2 slip referred to here and by a closed-loop control algorithm 15a for the Mode 1 slip referred to here.

The Mode 1 closed-loop control algorithm 15a provides, as controlled variable, an average pressure SW-MD or a variable derived therefrom, for example a corresponding position or actuation of a pressure control valve or the like, which leads to a particular transmissible torque and an average slip rotational speed of the slip arrangement 2. These may, as illustrated here, be received and implemented by a separate control unit 13a for an actuator 14a which activates the Mode 1 slip.

The Mode 2 closed-loop control algorithm 15b provides, as controlled variables SW-DM, the frequency, which is ascertained from the signal of the primary-side sensor 21, and also the amplitude and the phase angle of the modulation of a variable for an actuation of a slip device, in particular in the form of a clutch, which are ascertained from the signal S22 of the secondary-side sensor 22. These may, as illustrated here, be received and implemented by a separate control unit 13b for an actuator 14b which activates the Mode 2 slip.

In particular if the activation of the Mode 2 slip is performed by the same actuator 14a, 14b as the activation of the Mode 1 slip, the splitting into two different control units 13a, 13b can be omitted, such that all controlled variables are implemented by the same control unit 13a, 13b and one corresponding actuator 14a, 14b.

A data exchange 16 may take place between the closed-loop control algorithms 15a, 15b for the Mode 1 and the Mode 2 slip, for example in order to use the modulation amplitude for pilot control of the average slip rotational speed and prevent adhesion between the primary and secondary sides 3, 4 of the slip arrangement 2 even in the presence of large amplitudes. If the Mode 2 slip is already being operated with the maximum amplitude that can be provided by the associated actuator 13b, it is thus also possible to increase the average slip rotational speed by means of the actuator 14a in order to further improve the decoupling.

It may be advantageous to provide, for the closed-loop control device 6, starting values for phase and amplitude which shorten the response time when said closed-loop control device commences operation. By a parameter table, it is also possible for a target decoupling quality to be predefined for different operating points. The closed-loop control device 6 increases the amplitude of the modulation moment for the slip only until such time as the target decoupling quality has been attained, which leads to increased efficiency of the drive train.

In summary, the invention has inter alia the advantage that the decoupling and the efficiency of the drive train are improved. Furthermore, the damping of rotational irregularities in the drive train of motor vehicles is made possible in a reliable and efficient manner. A further advantage is that closed-loop control is performed in accordance with the actual decoupling requirement.

Although the present invention has been described on the basis of preferred exemplary embodiments, it is not restricted to these, but rather may be modified in a wide variety of ways.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-14. (canceled)

15. A damping arrangement configured to dampen rotational irregularities in a drive train of a motor vehicle, comprising:
a slip arrangement configured to provide slip between an input region of a torque-transmitting arrangement and an output region of the torque-transmitting arrangement, comprising:
a closed-loop control device configured to perform closed-loop control of the slip based at least in part on:
a measured signal for a rotational irregularity, and
at least one characteristic variable of a periodic oscillation component of an alternating component of a rotational speed proceeding from an average rotational speed; and
at least one sensor device connected to the closed-loop control device and configured to:
ascertain the average rotational speed in a torque-transmitting path downstream of the slip arrangement, and
ascertain a frequency of the alternating component in the torque-transmitting path upstream of the slip arrangement.

16. The damping arrangement as claimed in claim 15, wherein the at least one sensor device is configured to ascertain an amplitude of the rotational irregularities as a characteristic variable in the torque-transmitting path downstream of the slip arrangement.

17. The damping arrangement as claimed in claim 15, wherein the at least one sensor device comprises a position sensor for a shaft of a drive of the motor vehicle.

18. The damping arrangement as claimed in claim 15, further comprising:
a rotational irregularity pre-decoupling device, comprising at least one rotational-speed-adaptive absorber, arranged upstream of the slip arrangement,
wherein the at least one sensor device comprises a primary rotational speed sensor arranged in the torque-transmitting path downstream of the rotational irregularity pre-decoupling device and upstream of the slip arrangement.

19. The damping arrangement as claimed in claim 16, wherein the at least one sensor device comprises, to ascertain the amplitude of the rotational irregularities as the characteristic variable, at least one of a secondary rotational speed sensor and a secondary acceleration sensor arranged in the torque-transmitting path downstream of the slip arrangement.

20. The damping arrangement as claimed in claim 16, wherein a transmission is arranged in the torque-transmitting path downstream of the slip arrangement, and the at least one sensor device is configured to ascertain the amplitude of the rotational irregularity in the torque-transmitting path downstream of the transmission.

21. The damping arrangement as claimed in any of claim 15, wherein the at least one sensor device is directly connected to the slip arrangement.

22. The damping arrangement as claimed in claim 15, wherein the closed-loop control device comprises a memory that comprises starting values for the closed-loop control of the slip arrangement.

23. The damping arrangement as claimed in claim 15, wherein the closed-loop control device comprises a memory that contains one or more values, which represent a predefined decoupling quality, and wherein the closed-loop control device is configured to perform closed-loop control of an amplitude of the slip until a predefined decoupling quality is attained.

24. The damping arrangement as claimed in claim 15, wherein the slip arrangement comprises a clutch configured to provide an average slip, and the closed-loop control device is configured to provide an average slip based at least in part on the at least one characteristic variable.

25. A method for dampening rotational irregularities in a drive train of a motor vehicle, comprising:
providing slip between an input region of a torque-transmitting arrangement and an output region of the torque-transmitting arrangement by a slip arrangement;
performing closed-loop control of the slip by a closed-loop control device based at least in part on:
a measured signal for a rotational irregularity; and
at least one characteristic variable of a periodic oscillation component of an alternating component of a rotational speed proceeding from an average rotational speed; and
ascertaining by at least one sensor device connected to the slip arrangement the average rotational speed in a torque-transmitting path downstream of the slip arrangement and a frequency of the alternating component in the torque-transmitting path upstream of the slip arrangement.

26. The method as claimed in claim 25, further comprising:
ascertaining oscillation nodes of the periodic oscillation component in the torque-transmitting path; and
ascertaining the at least one characteristic variable by the at least one sensor device outside an ascertained oscillation nodes.

27. The method as claimed in claim 25, further comprising:
increasing an average slip by the slip arrangement if a predefined maximum of an amplitude of the alternating component has been reached.

28. The method as claimed in claim 25, wherein a target decoupling quality is predefined for at least two different positions in the torque-transmitting path, and an amplitude of the alternating component is increased only to such an extent that the target decoupling quality is reached and is then kept constant.

29. The damping arrangement as claimed in claim 17, wherein the position sensor is a crankshaft position sensor.

30. The damping arrangement as claimed in claim 19, wherein a transmission is arranged in the torque-transmitting path downstream of the slip arrangement, and the at least one sensor device is configured to ascertain the amplitude of the rotational irregularity in the torque-transmitting path downstream of the transmission.

31. The damping arrangement as claimed in any of claim 21, wherein the at least one sensor device is directly connected to the closed-loop control device.
